(19) United States
(12) Patent Application Publication
(10) Pub. No.: US 2020/0160394 A1
(43) Pub. Date: May 21, 2020

(54) VEHICLE INFORMATION MANAGING DEVICE AND VEHICLE INFORMATION MANAGING METHOD

(71) Applicant: TOYOTA JIDOSHA KABUSHIKI KAISHA, Aichi-ken (JP)

(72) Inventors: Ryohei OBARA, Nagakute-shi (JP); Masaki ITO, Toyota-shi (JP); Makoto KAKUCHI, Toyota-shi (JP); Mutsumi MATSUURA, Okazaki-shi (JP); Hiroaki SUGIYAMA, Nagoya-shi (JP); Yuichi TASHIRO, Owariasahi-shi (JP)

(21) Appl. No.: 16/683,316

(22) Filed: Nov. 14, 2019

(30) Foreign Application Priority Data
Nov. 16, 2018 (JP) 2018-215432

(51) Int. Cl. G06Q 30/02; G07C 5/00

(52) U.S. Cl. CPC G06Q 30/0266; G07C 5/008

(57) ABSTRACT

A vehicle information managing device includes an acquisition unit configured to acquire vehicle data on a vehicle which is traveling from the vehicle and a provision unit configured to provide advertisement information of a commercial facility which is selected based on user data on a user of the vehicle and the vehicle data to the vehicle which is traveling.

### INCORPORATION BY REFERENCE

The disclosure of Japanese Patent Application No. 2018-215432 filed on Nov. 16, 2018 including the specification, drawings and abstract is incorporated herein by reference in its entirety.

### BACKGROUND

### 1. Technical Field

The disclosure relates to a vehicle information managing device and a vehicle information managing method.

### 2. Description of Related Art

In the related art, a travel management system of a vehicle including a vehicle information communication device that transmits travel information of a vehicle, a management server that manages a travel state of a vehicle, and a mobile information terminal configured to access travel information of a vehicle which is automatically traveling and which is stored in the management server is known (see Japanese Unexamined Patent Application Publication No. 2018-112930 (JP 2018-112930 A)).

### SUMMARY

However, in the travel management system described in JP 2018-112930 A, there is lack of a motivation for a user of a vehicle to visit commercial facilities around a traveling route and to utilize these commercial facilities while traveling. Accordingly, utilization of commercial facilities is not promoted.

Therefore, the disclosure provides a vehicle information managing device and a vehicle information managing method that can promote utilization of a commercial facility around a route of a vehicle which is traveling.

According to an aspect of the disclosure, there is provided a vehicle information managing device including: an acquisition unit configured to acquire vehicle information on a vehicle which is traveling from the vehicle; and a provision unit configured to provide advertisement information of a commercial facility which is selected based on user information on a user of the vehicle and the vehicle information to the vehicle which is traveling.

According to another aspect of the disclosure, there is provided a vehicle information managing method including: acquiring vehicle information on a vehicle which is traveling from the vehicle; and providing advertisement information of a commercial facility which is selected based on user information on a user of the vehicle and the vehicle information to the vehicle which is traveling.

According to the disclosure, it is possible to promote utilization of a commercial facility around a route of a vehicle which is traveling.

### BRIEF DESCRIPTION OF THE DRAWINGS

Features, advantages, and technical and industrial significance of exemplary embodiments of the disclosure will be described below with reference to the accompanying drawings, in which like numerals denote like elements, and wherein:

FIG. 1 is a diagram schematically illustrating a configuration of a vehicle information management system according to an embodiment;

FIG. 2 is a diagram illustrating a data structure of a user data file illustrated in FIG. 1;

FIG. 3 is a diagram illustrating a data structure of a vehicle data file illustrated in FIG. 1;

FIG. 4 is a diagram illustrating a data structure of a commercial facility data file illustrated in FIG. 1; and

FIG. 5 is a flowchart schematically illustrating operations of a vehicle information managing device according to an embodiment.

### DETAILED DESCRIPTION OF EMBODIMENTS

Hereinafter, an embodiment of the disclosure will be described. In the following description in conjunction with the accompanying drawings, the same or similar elements will be referred to by the same or similar reference signs. The drawings are schematic. The technical scope of the disclosure should not be limited to the embodiment.

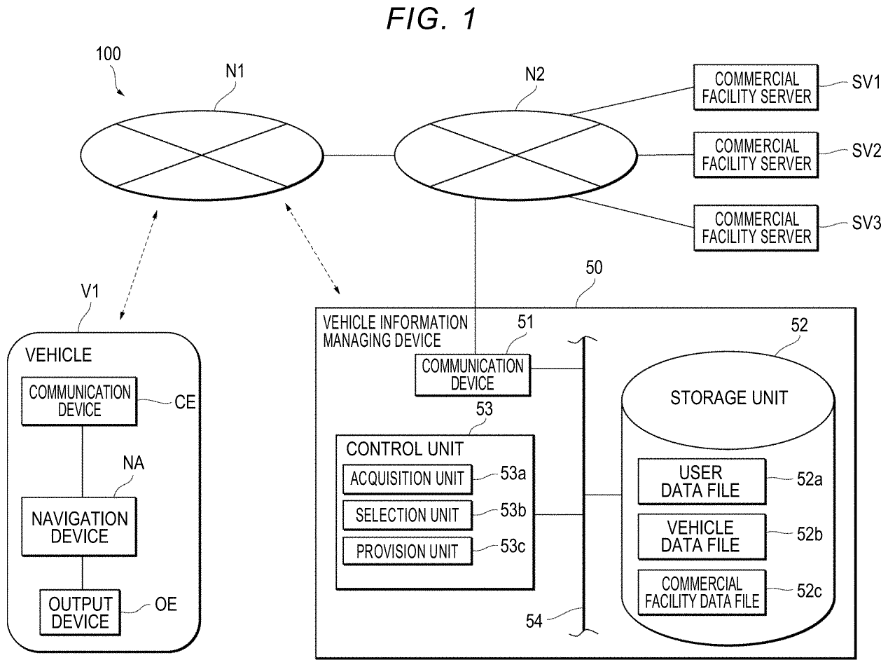

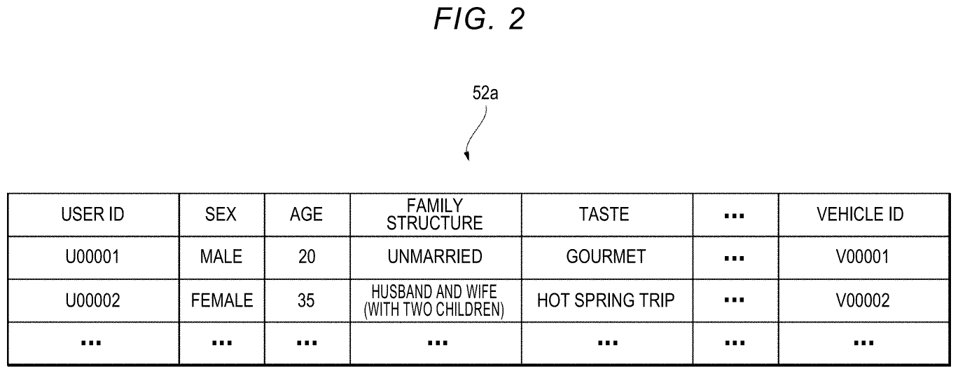

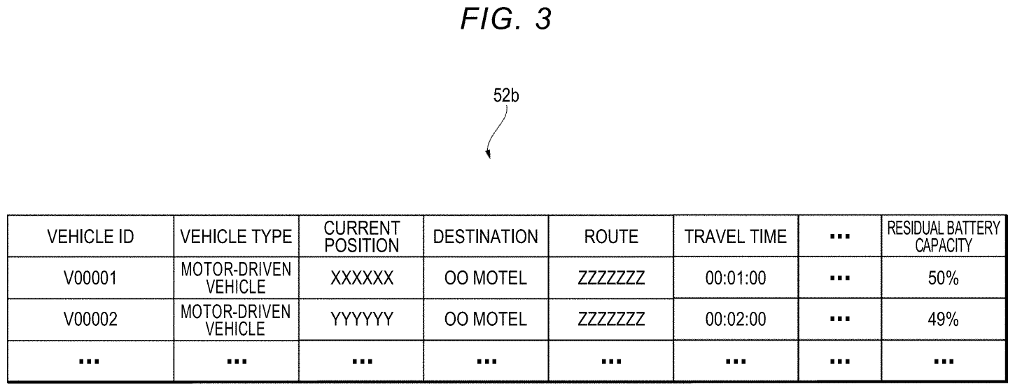

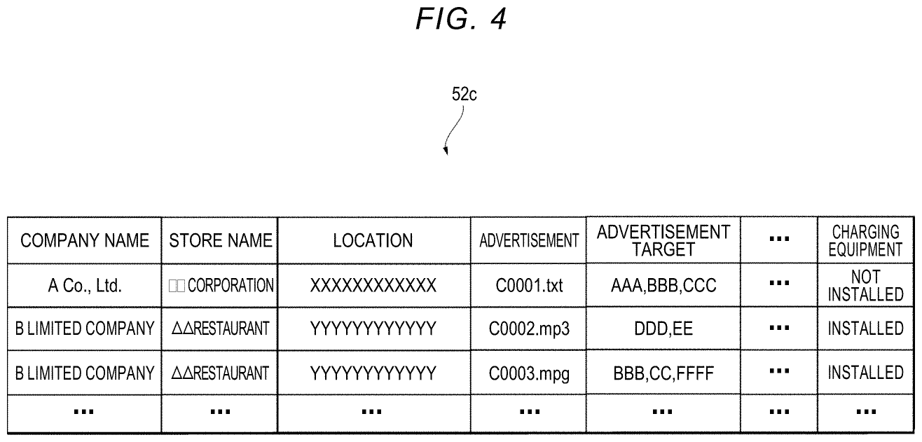

FIGS. 1 to 5 illustrate a vehicle information managing device and a vehicle information managing method according to an embodiment. First, a schematic configuration of a vehicle information management system according to the embodiment will be described below with reference to FIGS. 1 to 4. FIG. 1 is a diagram schematically illustrating a configuration of a vehicle information management system 100 according to the embodiment. FIG. 2 is a diagram illustrating a data structure of a user data file 52a illustrated in FIG. 1. FIG. 3 is a diagram illustrating a data structure of a vehicle data file 52b illustrated in FIG. 1. FIG. 4 is a diagram illustrating a data structure of a commercial facility data file 52c illustrated in FIG. 1.

As illustrated in FIG. 1, the vehicle information management system 100 includes a vehicle information managing device 50. The vehicle information management system 100 includes a network N1, a network N2, a vehicle V1, and commercial facility servers SV1, SV2, and SV3.

The vehicle V1 and the vehicle information managing device 50 are connected to communicate with each other via the network N1. The network N1 is, for example, a mobile communication network. The commercial facility servers SV1, SV2, and SV3 and the vehicle information managing device 50 are connected to communicate with each other via the network N2. The network N2 is, for example, the Internet, a local area network (LAN), a dedicated communication line, a telephone network, an intra-company network, Bluetooth (registered network), wireless fidelity (Wi-Fi), other communication lines, or combinations thereof. The network N1 and the network N2 are connected to each other. The network N1 and the network N2 may be connected to each other in a wired manner or a wireless manner.

In this embodiment, the number of networks N1 and N2 included in the vehicle information management system 100 is two in FIG. 1, but the disclosure is not limited thereto. The number of networks included in the vehicle information management system 100 may be one or three or more.

For example, a communication device CE, a navigation device NA, and an output device OE are mounted in the vehicle V1.

In this embodiment, the number of vehicles V1 included in the vehicle information management system 100 is one in FIG. 1, but the disclosure is not limited thereto. The number of vehicles included in the vehicle information management system 100 may be two or more.

When the number of vehicles included in the vehicle information management system 100 is two or more, vehicle IDs which are unique to all the vehicles included in the vehicle information management system 100 are allocated to the vehicles in order to identify the vehicles. Similarly, user IDs which are unique to all owners, drivers, or the like (hereinafter referred to as “users”) of the vehicles included in the vehicle information management system 100 are allocated to the users of the vehicles.

The navigation device NA is configured to perform guidance for a route to a destination from a current position. The navigation device NA includes a global positioning system (GPS) receiver and can acquire position information by GPS positioning. The navigation device NA may acquire position information, for example, by positioning using base stations (not illustrated) of the network N1 instead of the GPS positioning or in addition to the GPS positioning.

The navigation device NA is connected to the communication device CE and the output device OE. The navigation device NA outputs information such as a current position, a destination, and a route to the communication device CE at predetermined intervals.

The communication device CE is configured to communicate with the vehicle information managing device 50 via the network N1. For example, the communication device CE stores a vehicle ID of the vehicle V1 in its memory. The communication device CE is supplied with information such as a current position, a destination, and a route from the navigation device NA and is supplied with information such as a vehicle type and a traveling time from a device (not illustrated) which is mounted in the vehicle V1. When the vehicle 1 is a motor-driven vehicle, the communication device CE is also supplied with information of a residual battery capacity. The communication device CE transmits vehicle data which is generated by adding the vehicle ID to the information and which is information on the vehicle V1 which is traveling to the vehicle information managing device 50 via the network N1. The communication device CE receives advertisement information which will be described later from the vehicle information managing device 50 via the network N1.

The output device OE is configured to output information. The output device OE includes, for example, a display device such as a liquid crystal display, an electroluminescence (EL) display, or a plasma display and a speaker.

The output device OE is supplied with advertisement information via the navigation device NA. The output device OE displays information of text such as characters, numerals, and signs, a still image, and a moving image in the advertisement information on the display device and outputs information of speech from the speaker.

The term, “motor-driven vehicle,” in the disclosure refers to a vehicle which uses electricity as at least a part of power. Accordingly, a motor-driven vehicle includes a hybrid vehicle using electricity as at least one power source out of so-called hybrid vehicles using two or more power sources.

The term, “vehicle which is traveling,” in the disclosure is not limited to a vehicle which is actually running, but refers to a vehicle during the time from starting to stopping of a motor such as an engine or an electric motor.

The vehicle information managing device 50 serves to manage information which is acquired from the vehicle V1 of the vehicle information management system 100 and information which is provided to the vehicle V1. The vehicle information managing device 50 includes, for example, a communication unit 51, a storage unit 52, and a control unit 53. The vehicle information managing device 50 further includes a bus 54 which is configured to transmit signals or data between the units of the vehicle information managing device 50.

The communication unit 51 performs data communication (transmits and receives data). The communication unit 51 is configured to communicate with the vehicle V1 connected to the network N1 via the network N1 and is configured to communicate with the commercial facility servers SV1, SV2, and SV3 connected to the network N2 via the network N2, based on one or more predetermined communication modes. When the network N2 is the Internet, at least one communication mode of the communication unit 51 is a communication mode based on an Internet protocol.

The storage unit 52 is configured to store programs, data, and the like. The storage unit 52 includes, for example, a hard disk drive (HDD) or a solid-state drive (SSD). The storage unit 52 stores various programs which are executed by the control unit 53, data which is required for executing the programs, and the like in advance.

The storage unit 52 also stores a user data file 52a in advance. The user data file 52a is a file in which user data used to select advertisement information which will be described later is collected.

As illustrated in FIG. 2, user data for each user ID is stored as one record in the user data file 52a. User data is information on a user of the vehicle V1 and includes, for example, information such as sex, age, family structure, and taste. The user ID is correlated with the vehicle ID. Accordingly, a user can be identified from the vehicle ID and user data can be accessed.

Referring back to FIG. 1, the storage unit 52 also stores a vehicle data file 52b. The vehicle data file 52b is a file which is prepared, for example, for each vehicle and serves to store the vehicle data which is used to select advertisement information which will be described later.

As illustrated in FIG. 3, each piece of vehicle data which is transmitted from the vehicle V1 at predetermined intervals is stored as one record in the vehicle data file 52b. In the example illustrated in FIG. 3, vehicle data is transmitted at intervals of one minute and is stored in the vehicle data file 52b. Regarding storage in the vehicle data file 52b, for example, newest (latest) vehicle data is added as a final record of the vehicle data file 52b.

Referring back to FIG. 1, the storage unit 52 additionally stores a commercial facility data file 52c in advance. The commercial facility data file 52c is a file in which advertisement information which is to be provided to a vehicle is collected.

As illustrated in FIG. 4, commercial facility data for each piece of advertisement information on a commercial facility is stored as one record in the commercial facility data file 52c. Commercial facility data includes, for example, information such as a company name, a store name, and a location. The commercial facility data may include information on charging equipment such as information of whether there is charging equipment, the number of pieces of charging equipment, and charging equipment type.

Advertisement information is, for example, information of text such as characters, numerical, and signs, a still image, a moving image, speech, or a combination thereof. Information of an advertisement target indicating a user or a vehicle which is a target thereof is set in the advertisement information. Advertisement target information includes information on a user such as male as sex, forties as age, and husband and wife with a child as a family structure, information on a vehicle such as a motor-driven vehicle as a vehicle type and a lodging facility as a destination. The advertisement information and the advertisement target information are transmitted from the commercial facility servers SV1, SV2, and SV3 via the network N2 and are stored in the commercial facility data file 52c. The commercial facility servers SV1, SV2, and SV3 can transmit advertisement information and advertisement target information at an arbitrary time to update the advertisement information and the advertisement target information stored in the commercial facility data file 52c.

One commercial facility is not limited to one piece of advertisement information. A certain commercial facility may have two or more pieces of advertisement information provided therefor.

The structures and formats of the user data file 52a, the vehicle data file 52b, and the commercial facility data file 52c are not limited to the examples illustrated in FIGS. 2 to 4. For example, the user data file 52a, the vehicle data file 52b, and the commercial facility data file 52c may be simple data or databases. When at least some of the user data file 52a, the vehicle data file 52b, and the commercial facility data file 52c is a database, normalization may be performed thereon and group units of data may be segmented.

Referring back to FIG. 1, the control unit 53 is configured to control operations of the units of the vehicle information managing device 50 such as the communication unit 51, and the storage unit 52. The control unit 53 is configured to embody the functions which will be described later by executing a program stored in the storage unit 52. The control unit 53 includes, for example, a processor such as a central processing unit (CPU), a memory such as a read only memory (ROM) and a random access memory (RAM), and a buffer storage device such as a buffer.

The control unit 53 includes, for example, an acquisition unit 53a, a selection unit 53b, and a provision unit 53c as functional units thereof.

The acquisition unit 53a is configured to acquire the vehicle data from the vehicle V1 which is traveling. More specifically, the vehicle V1 transmits vehicle data via the network N1 at predetermined intervals, and the acquisition unit 53a acquires the vehicle data from the vehicle V1 which is traveling at predetermined intervals by receiving the vehicle data through the communication unit 51. Accordingly, newest vehicle data can be acquired from the vehicle V1 which is traveling.

The selection unit 53b is configured to select advertisement information which is to be provided to the vehicle V1 which is traveling out of a plurality of pieces of advertisement information based on the commercial facility data, the user data, and the vehicle data. In this way, by selecting advertisement information based on the commercial facility data including advertisement target information, it is possible to provide advertisement information to a vehicle or a user of the vehicle which is known as a target by the commercial facility. Accordingly, it is possible to provide effective advertisement for a commercial facility to a vehicle or a user of the vehicle.

For example, the selection unit 53b searches the commercial facility data file 52c based on the user data and the vehicle data and selects advertisement information which is to be provided. When the number of conditions which information included in the user data and the vehicle data satisfies out of a plurality of conditions for the advertisement target information is equal to or greater than a predetermined number, advertisement information in which the advertisement target information is set is selected as advertisement information which is to be provided to the vehicle V1 which is traveling. Specifically, the selection unit 53b selects advertisement information for advertisement target information in which three or more items as a majority of five items in the conditions for advertisement target information are satisfied. When there is a plurality of pieces of selected advertisement information, the selection unit 53b may select one closest to the conditions of the advertisement target information or may select all the pieces of advertisement information.

The provision unit 53c is configured to provide advertisement information which is selected based on the user data and the vehicle data to the vehicle V1 which is traveling.

In this way, by providing advertisement information to the vehicle V1 which is traveling, a motivation for a user of a vehicle to visit a commercial facility and to utilize the commercial facility while traveling can be given based on the advertisement information. By determining advertisement information based on user data and vehicle data, appropriate (useful or helpful) advertisement information can be provided to a user of the vehicle and/or the vehicle and thus a likelihood that the user will visit and utilize the commercial facility can be increased. Accordingly, it is possible to promote use of a commercial facility around a route of a vehicle which is traveling. When utilization of a commercial facility is promoted, an increase of sales in the commercial facility can be expected and thus costs such as maintenance costs and running costs of the vehicle information management system can be recovered, for example, by receiving an incentive from the commercial facility in return for provision of advertisement information.

More specifically, the provision unit 53c is configured to provide advertisement information selected by the selection unit 53b to the vehicle V1 which is traveling. When there is a plurality of pieces of selected advertisement information, the plurality of pieces of advertisement information may be provided together or the plurality of pieces of advertisement information may be individually provided. Provision of advertisement information to the vehicle V1 which is traveling is performed by data transmission via the communication unit 51 and the network N1. The vehicle V1 receives the advertisement information provided from the provision unit 53c via the communication device CE and outputs the received advertisement information to the output device OE connected to the navigation device NA.

The selection unit 53b is configured to provide advertisement information of a commercial facility including charging equipment to the vehicle V1 which is traveling when the vehicle type information included in the vehicle data is a “motor-driven vehicle.” Specifically, the selection unit 53b selects advertisement information of commercial facility data in which charging equipment information is set to “installed” in the commercial facility data file 52c. In this way, when the vehicle type information included in the vehicle data is “motor-driven vehicle,” it is possible to increase the likelihood that a user of the motor-driven vehicle will use a commercial facility having charging equipment installed therein by providing advertisement information of the commercial facility to the vehicle V1 which is traveling.

When the vehicle type information included in the vehicle data is “motor-driven vehicle” and residual battery capacity information included in the vehicle data is equal to or less than a predetermined value, for example, “49%,” the selection unit 53b may be configured to provide advertisement information of a commercial facility having charging equipment installed therein to the vehicle V1 which is traveling. In this case, the selection unit 53b selects advertisement information of commercial facility data in which charging equipment information is set to “installed” in the commercial facility data file 52c. In this way, when the vehicle type information included in the vehicle data is “motor-driven vehicle” and the residual battery capacity information included in the vehicle data is equal to or less than a predetermined value, it is possible to increase the likelihood that a user of the motor-driven vehicle will use a commercial facility having charging equipment installed therein by providing advertisement information of the commercial facility to the vehicle V1 which is traveling.

It is preferable that commercial facility of which advertisement information is provided be located in a region with a population equal to or less than a predetermined value. Accordingly, use of the commercial facility is promoted and thus it is possible to activate an underpopulated region.

The functions of the control unit 53 can be embodied by causing a computer (a microprocessor) to execute a program. Accordingly, the functions of the control unit 53 can be embodied in hardware, software, or a combination of hardware and software, and there is no limitation to any one case.

When the functions of the control unit 53 are embodied in software or a combination of hardware and software, the processes can be performed by multitasking, multithreading, or both of multitasking and multithreading, and there is no limitation to any one case.

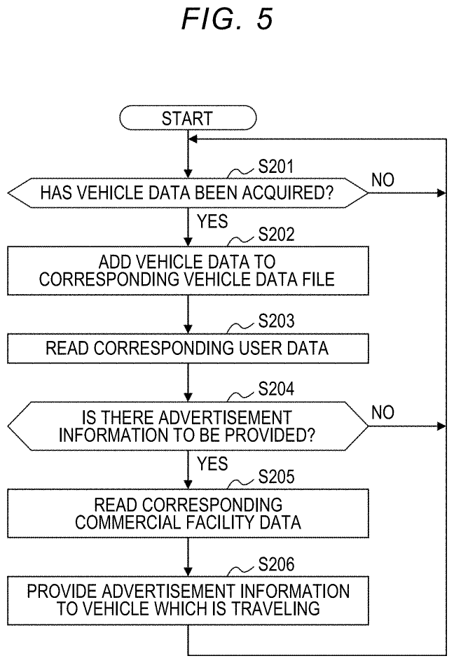

Operations of the vehicle information managing device according to this embodiment will be described below with reference to FIG. 5. FIG. 5 is a flowchart schematically illustrating the operations of the vehicle information managing device according to this embodiment.

For example, when the vehicle information managing device 50 is powered on, the vehicle information managing device 50 performs a vehicle information managing process S200 illustrated in FIG. 5.

First, the acquisition unit 53a determines whether vehicle data has been acquired from the vehicle V1 which is traveling via the network N1 and the communication unit 51 (S201). The acquisition unit 53a repeats the determination of step S201 until vehicle data is acquired from the vehicle V1.

When it is determined in step S201 that vehicle data has been acquired, the acquisition unit 53a adds the acquired vehicle data to the vehicle data file 52b of which the vehicle ID matches the vehicle ID included in the vehicle data (S202).

Then, the selection unit 53b reads corresponding user data including the vehicle ID included in the acquired vehicle data from the user data file 52a (S203).

Then, the provision unit 53c determines whether there is advertisement information which is to be provided to the vehicle V1 which is traveling (S204). Regarding determination of whether there is advertisement information which is to be provided, for example, the selection unit 53b has selected advertisement information based on the commercial facility data, the user data, and the vehicle data, and the provision unit 53c determines that there is advertisement information which is to be provided when at least one piece of advertisement information has been selected and determines that there is no advertisement information which is to be provided when no advertisement information has not been selected.

When it is determined in step S204 that there is advertisement information which is to be provided to the vehicle V1 which is traveling, the provision unit 53c reads commercial facility data including advertisement information to be provided from the commercial facility data file 52c (S205).

Then, the provision unit 53c transmits advertisement information included in the commercial facility data read in step S205 via the communication unit 51 and the network N1 and provides the advertisement information to the vehicle V1 which is traveling (S206).

On the other hand, when it is determined in step S204 that there is not advertisement information which is to be provided to the vehicle V1 which is traveling or after step S206, the control unit 53 returns to step S201 and starts the vehicle information managing process S200 again.

The vehicle information managing device 50 repeatedly performs the vehicle information managing process S200, for example, until the vehicle information managing device 50 is powered off.

An exemplary embodiment of the disclosure has been described above. With the vehicle information managing device 50 and the vehicle information managing method according to this embodiment, advertisement information is provided to a vehicle V1 which is traveling. Accordingly, motivation for a user of a vehicle to visit a commercial facility and to utilize the commercial facility while traveling can be given based on the advertisement information. The advertisement information is determined based on user data and vehicle data. Accordingly, appropriate (useful or helpful) advertisement information can be provided to a user of a vehicle and/or the vehicle and thus it is possible to increase a likelihood that the user will visit and utilize the commercial facility. Accordingly, it is possible to promote use of a commercial facility around a route of a vehicle which is traveling. When utilization of a commercial facility is promoted, an increase of sales in the commercial facility can be expected and thus costs such as maintenance costs and running costs of the vehicle information management system can be recovered, for example, by receiving an incentive from the commercial facility in return for provision of advertisement information.

The above-mentioned embodiment is for facilitating understanding of the disclosure, but not for definitively construing the disclosure. Elements of the embodiment and arrangements, materials, conditions, shapes, sizes, and the like thereof are not limited to those described in the embodiment and can be appropriately modified. Elements described in different embodiments can be partially replaced or combined.

What is claimed is:

1. A vehicle information managing device comprising:
an acquisition unit configured to acquire vehicle information on a vehicle which is traveling from the vehicle; and
a provision unit configured to provide advertisement information of a commercial facility which is selected based on user information on a user of the vehicle and the vehicle information to the vehicle which is traveling.

2. The vehicle information managing device according to claim 1, further comprising a selection unit configured to select the advertisement information which is to be provided to the vehicle which is traveling out of a plurality of pieces of advertisement information based on commercial facility information on the commercial facility including advertisement target information indicating a target of the advertisement information, the user information, and the vehicle information.

3. The vehicle information managing device according to claim 2, wherein the vehicle information includes vehicle type information indicating a vehicle type, and
wherein the selection unit is configured to select the advertisement information of a commercial facility having charging equipment for the vehicle which is traveling when the vehicle type information included in the vehicle information indicates a motor-driven vehicle.

4. The vehicle information managing device according to claim 3, wherein the vehicle information further includes residual battery capacity information indicating a residual battery capacity, and
wherein the selection unit is configured to provide the advertisement information of a commercial facility having charging equipment to the vehicle which is traveling when the vehicle type information included in the vehicle information indicates a motor-driven vehicle and the residual battery capacity information included in the vehicle information is equal to or less than a predetermined value.

5. The vehicle information managing device according to claim 1, wherein the acquisition unit is configured to acquire the vehicle information from the vehicle which is traveling at predetermined intervals.

6. The vehicle information managing device according to claim 1, wherein the commercial facility is located in a region with a population equal to or less than a predetermined value.

7. A vehicle information managing method comprising:
acquiring vehicle information on a vehicle which is traveling from the vehicle; and
providing advertisement information of a commercial facility which is selected based on user information on a user of the vehicle and the vehicle information to the vehicle which is traveling.
